(19) United States
(12) Patent Application Publication
(10) Pub. No.: US 2016/0179748 A1
(43) Pub. Date: Jun. 23, 2016

(54) METHOD AND APPARATUS FOR ESTIMATING WAVEFORM ONSET TIME

(71) Applicant: Lawrence R. Weill, Seal Beach, CA (US)

(72) Inventor: Lawrence R. Weill, Seal Beach, CA (US)

(21) Appl. No.: 14/971,923

(22) Filed: Dec. 16, 2015

Related U.S. Application Data
(60) Provisional application No. 62/124,441, filed on Dec. 18, 2014.

(51) Int. Cl. G06F 17/13

(52) U.S. Cl. CPC G06F 17/13

(57) ABSTRACT

The invention described herein is directed to a method and apparatus for estimating an onset time t₀ of a noisy waveform by producing a time t₁ that a magnitude of the noisy waveform crosses a positive threshold T which is as small as possible while keeping the probability of false crossings due to noise at an acceptable level. The estimate of the onset time t₀ uses an initial portion of a noisy waveform magnitude leading edge to avoid errors due to later-occurring multipath components. The invention also produces a derivative of the noisy waveform magnitude at time t₁, which is used to normalize against errors due to variations to power level without having to use any portion of the noisy waveform beyond time t₁. The waveform to which the invention applies can be a received signal, the cross-correlation function derived from a received signal, or another waveform where onset time needs to be estimated.

### RELATED APPLICATIONS

This application claims the benefit of priority of U.S. Provisional Application Ser. No. 62/124,441 to Weill, which was filed on Dec. 18, 2014. U.S. Provisional Application Ser. No. 62/124,441, including its drawings, schematics, diagrams and written description, is hereby incorporated in its entirety by reference.

### BACKGROUND OF THE INVENTION

1. Field of the Invention

This invention relates most generally to wireless positioning systems using radio frequency transmissions, but has other applications where the onset time of a waveform is to be estimated.

2. Description of the Related Art

Measuring the distance from a transmitter to a receiver (ranging) is fundamental to a wide variety of positioning systems. A typical positioning system comprise a group of radio frequency (RF) transmitters at known locations and a receiver whose position is to be found by measuring its distance from each transmitter in the group. With a sufficient number of transmitters arranged in a suitable geometric configuration, a unique position of the receiver can be mathematically determined from the set of measured transmitter-to-receiver distances, a process commonly referred to as triangulation.

Typically, each of these distances is determined by measuring the time it takes for the signal to propagate from a transmitter to the receiver and multiplying the propagation time by the speed of light (about 3×10⁸ meters/sec). Because the propagation time is the difference between the signal time of arrival (TOA) at the receiver and the time of signal transmission, accurate estimation of signal TOA is necessary to obtain a highly accurate position.

A wide variety of waveforms can be used for the signal, such as pulses of various shapes, sequences of such pulses, or continuously transmitted waveforms. Typically these waveforms phase modulate, frequency modulate, or amplitude modulate a carrier frequency. The carrier frequency, typically measured in megahertz (MHz) or gigahertz (GHz), lies within a RF bandwidth in which the positioning system operates. At the receiver, the waveforms are typically recovered from the carrier by a process referred to as demodulation.

Today, global navigation systems for determining location are of major importance. Examples are the U.S. Global Positioning System (GPS), the European system Galileo, and the Russian system Glonass. In these systems the measured ranges are on the order of thousands of kilometers, because the signals are transmitted from satellites. Due to the large propagation distances involved, the received signals are very weak and typically embedded in unavoidable thermal noise generated in any receiver. The carrier frequencies used by the satellite-based systems are typically in the 1-2 GHz range.

Although global systems generally have worldwide coverage and are usually accurate enough for many applications, a major disadvantage is that their weak signals have great difficulty penetrating obstacles to the propagation path, such as in urban canyons or heavy vegetation. In many cases this makes it difficult or impossible to obtain the position of a receiver in such areas, particularly within buildings.

To overcome this problem, local positioning systems are continuing to be developed, where the transmitter-to-receiver measured ranges might be out to 100-500 meters, permitting the received signals to be orders of magnitude stronger than in global systems. Thus, the signals can more easily pass through walls and other objects and still be strong enough to be usable at the receiver. The best of these systems will typically provide positioning accuracy within a few meters, and usually use ground-based transmitters located in a specific geographic area, such as within or near a building, a group of buildings, or in a somewhat wider area such as portions of a city.

A serious source of error can be found in conventional local positioning systems, especially when used indoors. If the transmitted signal simply propagates in an unobstructed straight line directly from transmitter to receiver, referred to as direct path or line-of-sight (LOS) propagation, estimating the TOA of the received signal is relatively straightforward. However, the received LOS signal is more often than not combined with additional delayed versions of the signal caused by reflections from a multiplicity of nearby objects. This phenomenon is generally called multipath propagation, which distorts the received waveform in an unpredictable manner and can cause unacceptable errors in estimating the TOA of the signal.

To gain an understanding of how multipath causes TOA error, first consider two common methods of measuring transmitter-to-receiver range. The first method is to transmit individual pulses to a receiver, and the second is to transmit a pseudorandom noise (PN) code. With reference to FIG. 1, an example of the first method is to send a rectangular pulse. If the pulse is received later without multipath, the received single pulse signal 10 might appear as shown at the top of FIG. 1. The received single pulse signal 10 has been filtered in the transmitter and receiver. Thermal noise in the receiver is added to the received pulse, but for simplicity this is not shown. FIG. 1 further shows the cross-correlation function 11 produced by using a receiver-generated replica 12 of the pulse, where the peak magnitude of the cross-correlation function is normally used to determine the TOA of the signal. Also shown is the onset time t₀ of the cross-correlation main lobe, which is to be estimated by the invention.

FIG. 2 is an example of the second method, wherein the transmitted PN code is a sequence of rectangular pulses called chips abutting each other, where the received pulses 20 have pseudorandom positive and negative polarities, as shown at the top of FIG. 2 in the absence of noise. Usually the sequence repeats periodically, with N chips in each period. FIG. 2 further discloses the received PN-coded signal without multipath, and its cross-correlation function 21 produced by using a receiver-generated replica 22 of the PN-coded signal, where the peak magnitude of the cross-correlation function is normally used to determine the TOA of the signal. Also shown is the onset time τ₀ of the cross-correlation main lobe, which is to be estimated by the invention.

For both methods, the optimal receiver processing against noise to obtain the signal TOA estimate for a LOS signal (no multipath) is to use cross-correlation. This is done by multiplying the received signal by a noiseless replica of the transmitted signal waveform, followed by integration (summation) of the product. This process is performed at different values of relative time shift τ between the received signal and replica to produce a cross-correlation function R(τ). In most receivers the cross-correlation function is expressed as

$$R ( τ ) = {\int }_{{T}_{1}}^{{T}_{2}} s ( t ) r ( t - τ ) d t \qquad ( 1 )$$

where s(t) is the received signal (including noise) at baseband (after having been shifted to zero frequency) and r(t) is the replica waveform (usually digitally generated). Normally r(t) is real-valued and the baseband signal s(t) is complex-valued, having a real part s₁(t) called the real, or in-phase component and an imaginary part s_{Q}(t) called the imaginary, or quadrature component. The complex signal is s(t)=s₁(t)+js_{Q}(t), where j=\sqrt{−1}. A complex value includes the case where the value is purely real, i.e., when the imaginary part is zero. For individual pulse ranging the time interval from T₁ to T₂ is chosen to encompass the received signal, and for PN code ranging the interval is usually chosen to be a multiple of the PN code period. For both methods the magnitude of R(τ) for a LOS signal has a triangular shaped main lobe as shown respectively in FIGS. 1 and 2, with some rounding due to filtering in the transmitter and receiver. The width of the main lobe at its base is 2W seconds, where W is the length of the transmitted pulse for individual pulse transmission and W is the length of a chip for PN code transmission. In FIGS. 1 and 2 a real signal s(t) is shown for simplicity, but it can be complex.

A PN code is typically used when an individual pulse does not have enough signal-to-noise ratio (SNR) at the receiver. This is conveyed by the higher peak of R(τ) for a PN code shown in FIG. 2. A PN code also protects against interference by spreading the interference power over a wide frequency range so that it can mostly be filtered out.

Except for an error due to noise, R(τ) has its maximum magnitude when r(t) is in time alignment with a LOS (no multipath) signal, i.e., when the relative time shift τ is close to zero. Since the receiver-generated replica 12, 22 is in alignment with the received signal, estimation of the signal TOA can be accomplished by means well-known in the art. This involves time-tagging specific points on the transmitted signal and receiver-generated replica waveforms, and observation of the timing of the replica in accordance with a receiver time base (such as a clock). For a LOS signal, the TOA estimation error is primarily due to noise.

However, in the presence of multipath the cross-correlation function becomes corrupted and causes errors in estimating TOA. FIG. 3 illustrates the effect on R(τ) when it has a component 30 from a LOS signal and another component 32 from a secondary path signal. The result is a TOA estimation error due to a shift in the location of the peak magnitude of R(τ). From the figure it is clearly seen that multipath signal components arriving with delays up to W seconds relative to the LOS signal can cause errors in estimating TOA. In indoor systems, there can be many such multipath components. Because the LOS signal can be greatly attenuated by passing through obstructions, some of the multipath components can be much larger than the LOS signal if they have a less attenuated route. As a result, TOA estimation errors can be unacceptably large.

Various methods have been devised for reducing the effects of multipath, many of them having been developed for global navigation systems. However, in local positioning systems, multipath signal propagation is often much more severe than in global systems, especially in indoor positioning where reflections occur from walls and numerous other objects. Furthermore, close-in multipath is much more of a problem, where the delay of secondary propagation paths relative to the LOS path can be quite small with much overlap of the respective waveforms. In light of the current demand for sub-meter accuracy in local systems, particularly indoors, the multipath mitigation technology developed for global navigation systems is generally inadequate.

It is well-known that transmitting wide-bandwidth signals (such as very short pulses) can reduce multipath error, by reducing the width of the cross-correlation function. This permits the secondary path signal components to be more easily separated from the desired LOS component.

The use of very wide bandwidth signals is referred to as ultra-wide bandwidth (UWB) technology. UWB signals generally occupy a frequency band from 3.1 GHz to 10.6 GHz, a total bandwidth of 7.5 GHz, which includes other signals that share this portion of the RF spectrum.

However, to avoid interference to these sharing signals, Federal Communications Commission (FCC) regulations limit the transmitted power of UWB signals to small values at the sub-milliwatt level. For indoor positioning, this severely limits the distance that the signals can be received, especially when passing through walls and floors of a building. Thus, UWB signals cannot provide reliable indoor positioning when transmitter to receiver distances exceed a limited range, which might be 10 meters or less if there are many obstacles to LOS propagation.

For local ranging at distances significantly larger than this, signals with a higher power and smaller bandwidth are used. Examples are signals permitted in the Industrial, Scientific, and Medical (ISM) bands. In the three ISM bands 902-928 MHz, 2.400-2.4835 GHz, and 5.725-5.875 GHz, the maximum transmitted power is 1 watt, as contrasted with the sub-milliwatt levels allowed for UWB transmissions. The respective widths of these bands are 26 MHz, 83.5 MHz, and 150 MHz. The higher allowable transmitted power yields usable signals for indoor positioning out to roughly 100-500 meters or more from each transmitter. However, this extended range comes at a price. Since the bandwidths are much smaller than the UWB bandwidth, multipath mitigation becomes more difficult.

A promising idea for reducing multipath errors in local positioning systems that has been developed in various forms is generically called a leading edge approach. It is not as practical for global navigation systems, because it requires a much higher received power level than a global system can provide. The leading edge approach is based on the fact that arriving multipath signal components are always delayed relative to the LOS component.

The conventional leading edge method usually operates either directly on the received signal or on the cross-correlation function. In the basic individual-pulse ranging technique previously described, operating directly on the signal means abandoning cross-correlation and observing only the initial portion 40 of the received pulse s(t), as shown in FIG. 4A (noise is omitted for clarity). The idea is to use this observation to estimate the time t₀ at which the noiseless pulse is just beginning, defined here as the onset time of the pulse (in this case, t₀ can be regarded as the signal TOA). Any multipath components occurring after the observed initial portion of the arriving pulse can have no effect on the estimate. Therefore, it is desirable to limit the observation to the earliest portion of the leading edge that is practical. This technique is no longer optimum for purely LOS signals, primarily because measurements are made on a low-SNR portion of the signal, and the full power and full shape of the signal is not exploited. However, this is offset by the relatively high received power levels obtainable in local positioning systems, and a much greater ability to neutralize most of the multipath signal components by using the beginning of the leading edge.

FIG. 4B illustrates the conventional leading edge approach applied to a typical cross-correlation function. Here the onset time τ₀ of the cross-correlation function is estimated, which can be converted to signal TOA by the receiver in a manner similar to that previously explained for the conventional method of converting the peak location to TOA. In this case τ₀ is defined as the value of time shift τ where the cross-correlation magnitude 42 just begins to rise toward its main lobe. A problem in using a typical cross-correlation function is that the relatively small slope of the edge degrades the accuracy in estimating τ₀. Later a special type of cross-correlation will be described which removes this difficulty.

Estimation of onset time generally requires detection of when a waveform magnitude crosses a positive threshold T that is set near the receiver noise level, but far enough above it to avoid false crossings from noise alone. However, the problem with such a simple arrangement is that the received signal power can have a wide range of values, depending on factors such as transmitter power, propagation losses, antenna gains, and receiver gain. This causes the time of threshold crossing to have a bias error that varies in accordance with received power, which is not desirable.

To get around this problem, it would be natural to think of dividing the waveform by its peak value to obtain a normalized version independent of power level, or to use automatic gain control (AGC) for this purpose. The use of AGO normalization for pulse signals can be found in U.S. Pat. No. 5,266,953 to Kelley et al. (“Kelley”), “Adaptive fixed-Threshold Pulse Time-of-Arrival Detection Apparatus for Precision Distance Measuring Equipment Applications,” issued Nov. 30, 1993. For indoor positioning, the difficulty with the type of normalization of Kelley is that multipath signal components, which can be very large at the location of the peak, can dramatically change the peak value and destroy the fidelity of the normalization. Kelley also describes using the times of two threshold crossings by a received pulse to address a table of multipath corrections. However, the second threshold crossing must extend further into the received pulse, where multipath is more likely. Additionally, there would still be major difficulties if this approach were used for indoor positioning, where the potentially large and complicated multipath environment found there would preclude the use of a correction table.

A method of estimating the onset time of a correlation function has been disclosed in the paper “Peak and Leading Edge Detection for Time-of-arrival Estimation in Band-limited Positioning Systems,” by I. Sharp, K. Yu, and Y. J. Guo, in IET Communications, vol. 3, issue 10, pp. 1616-1627, 2009. However, the method, called the Projection Algorithm, uses information located quite far beyond the onset time of the correlation function, where severe indoor multipath can cause serious errors.

What is needed is a method of using the smallest possible initial portion of a waveform in noise to accurately estimate the onset time of the waveform with minimal multipath error, such that the estimate does not have a bias depending on waveform amplitude. The source of the waveform can be arbitrary. For example, it could be a received pulse sent by a transmitter, a processed signal such as a cross-correlation function, or some other waveform having an onset time that needs to be estimated.

### SUMMARY

The invention provides various embodiments of systems and improved leading-edge methods of detecting the onset time of a waveform based on observing a noisy version of the waveform which contains multipath components. Although the source of the waveform can be arbitrary, the primary motivation is the need for better multipath mitigation and signal tracking in local positioning systems. An important application is for RF-based indoor positioning, where location accuracy at the sub-meter level is desired, but difficult to achieve with existing technology.

In one embodiment, as broadly described herein, a method for estimating an onset time t₀ from observation of a complex waveform

f(t)=Ae^{jφ}g(t−t₀)+m(t)+n(t)

wherein t is a time variable, A is a positive amplitude factor, φ is a phase, g(t) is a known differentiable real-valued function which is zero for t≦0 and increasing for a sufficiently long time thereafter, m(t) is a corrupting complex waveform which begins after time t₀, n(t) is a complex noise random process, and j=\sqrt{−1}, comprising the steps of: receiving the complex waveform f(t), computing a magnitude function F(t) of the complex waveform, computing a derivative F′(t) of the magnitude function, determining a time t₁ that the magnitude function F(t) crosses a positive threshold T, sampling the derivative F′(t) at the time t₁ to derive a value d=F′(t₁), and estimating an onset time t₀ of the function g(t−t₀) according to a formula

$${t}_{0} = {t}_{1} - {h}^{- 1} ( \frac{T}{d} )$$

wherein a function h⁻¹ is an inverse of a function

$$h ( t ) = \frac{g ( t )}{{g}^{′} ( t )} .$$

In another embodiment, as broadly described herein, a wireless communications device is disclosed that estimates an onset time an onset time t₀ from observation of a complex waveform

f(t)=Ae^{jφ}g(t−t₀)+m(t)+n(t)

wherein t is a time variable, A is a positive amplitude factor, φ is a phase, g(t) is a known differentiable real-valued function which is zero for t≦0 and increasing for a sufficiently long time thereafter, m(t) is a corrupting complex waveform which begins after time t₀, n(t) is a complex noise random process, and j=\sqrt{−1}, said device comprising: a magnitude function generator, a differentiator, a threshold crossing detector, wherein an output of the magnitude function generator is supplied to each of the differentiator and threshold crossing detector, a time base generator configured to provide a time base generator signal to the threshold crossing detector, a sampler coupled to an output of said differentiator, and an onset time calculator, wherein outputs of at least the sampler and threshold crossing detector are supplied to the onset time calculator to estimate the onset time t₀.

These and other aspects and advantages of the invention will become apparent from the following detailed description and the accompanying drawings which illustrate by way of example the features of the invention.

### BRIEF DESCRIPTION OF THE DRAWINGS

FIG. 1 is a conventional method of measuring transmitter to receiver range without multipath.

FIG. 2 is another conventional method of measuring transmitter to receiver range without multipath.

FIG. 3 is a conventional method of measuring transmitter to receiver range with multipath.

FIG. 4A is a conventional leading edge method of measuring transmitter to receiver range.

FIG. 4B is another conventional leading edge method of measuring transmitter to receiver range.

FIG. 5 is a plot of the initial portion of the magnitude function F(t) of a received single-pulse signal according to an embodiment of the invention.

FIG. 6 is a block diagram of a wireless communications device according to an embodiment of the invention.

FIG. 7 is waveform of a cross-correlation function to measure transmitter to receiver range according to an embodiment of the invention.

FIG. 8 is a waveform of the cross-correlation function of FIG. 7 with multipath according to an embodiment of the invention.

FIG. 9 is a diagram of error curves of transmitter to receiver range measurement simulations according to an embodiment of the invention.

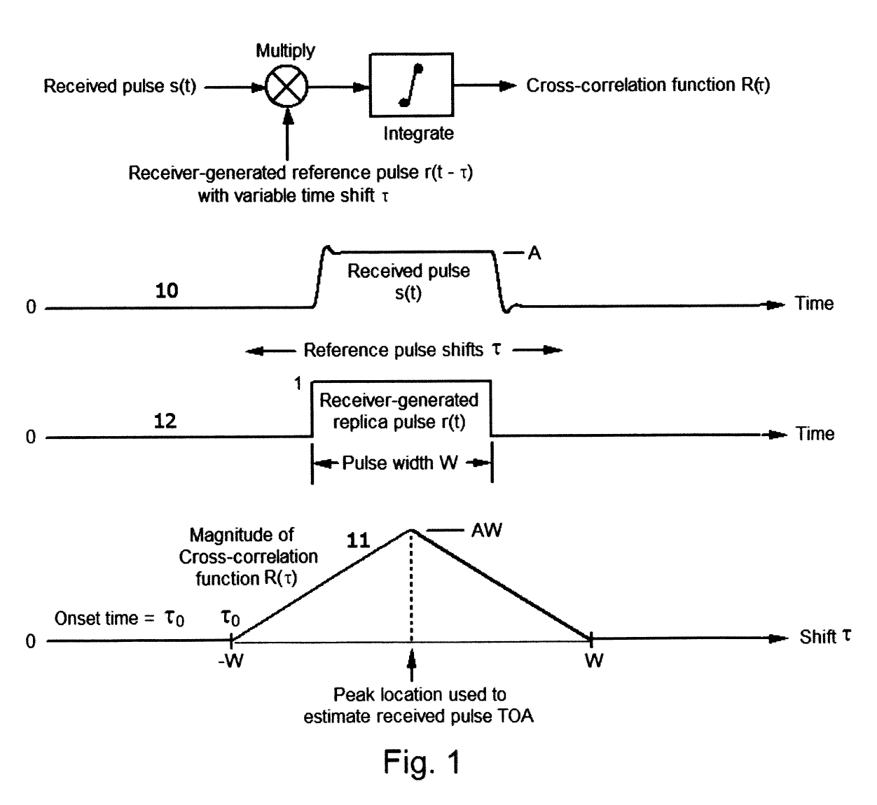

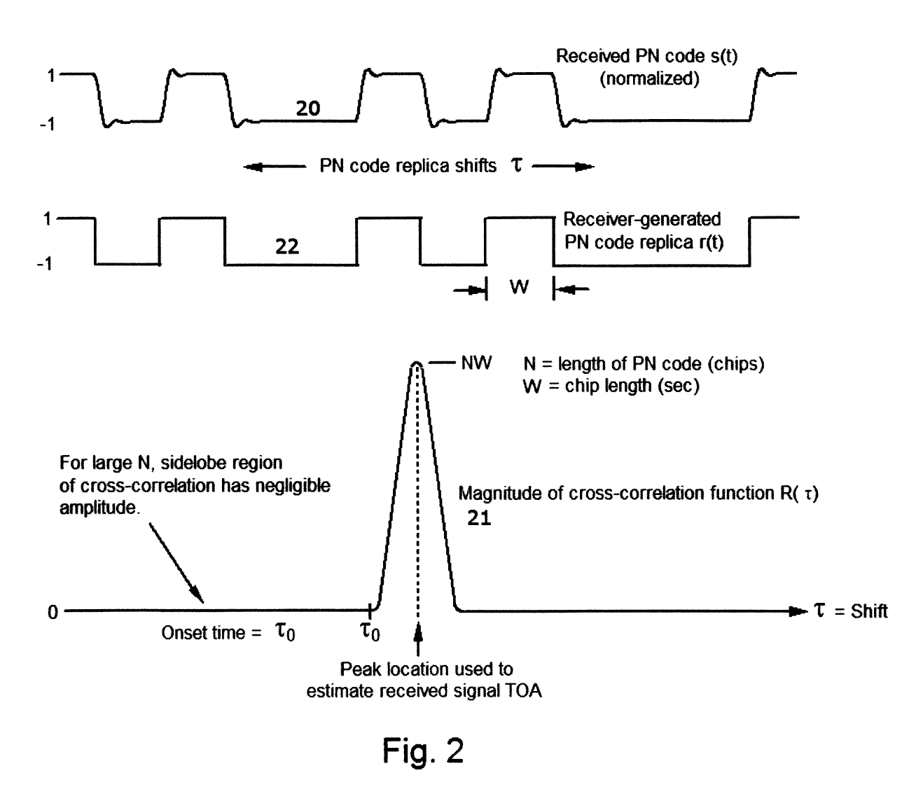

### DETAILED DESCRIPTION

The invention described herein is directed to different embodiments of a wireless communications device that can be used in many different applications, such as but not limited to detecting the onset time of a waveform and mitigating variations in received power levels due to noise and multipath.

The invention uses a new normalization process to reduce biases in estimating the onset time of a waveform caused by variation in received power levels when noise and multipath are present. This normalization uses the time that the magnitude of the waveform observation crosses a small positive threshold in combination with the derivative of this magnitude at the same time. Thus, only a very small part of the waveform following its onset is involved. Later parts of the waveform containing multipath components which can corrupt the normalization process are avoided.

The invention can be applied to obtain an accurate TOA estimate within a receiver of an arriving signal from a transmitter or from a processed signal, such as a cross-correlation function. Simulations using the 2.400-2.4835 GHz ISM band indicate that use of the invention can bring positioning errors down to within a few decimeters. The invention could also be used to improve multipath mitigation of UWB signals in positioning applications where a much smaller coverage area is acceptable.

The invention is described herein with reference to certain embodiments, but it is understood that the invention can be embodied in many different forms and should not be construed as limited to the embodiments set forth herein. In particular, the present invention is described herein in regards to multipath mitigation and signal tracking in local positioning systems in different configurations, but it is understood that the invention can be used for many other positioning systems having many different configurations and/or in other wireless systems wherein the distance from the transmitter to a receiver is measured.

Although the terms first, second, etc. may be used herein to describe various elements or components, these elements or components should not be limited by these terms. These terms are only used to distinguish one element or component from another. Thus, a first element discussed herein could be termed a second element without departing from the teachings of the present application. It is understood that actual systems or fixtures embodying the invention can be arranged in many different ways with many more features and elements beyond what is shown in the figures.

Embodiments of the invention are described herein with reference to waveform illustrations that are schematic illustrations. As such, the actual waveforms can be different, and variations from the waveforms as a result, for example, of noise are expected. Thus, the waveforms illustrated in the figures are schematic in nature and their shapes are not intended to illustrate the precise shape of a transmitted, received and/or processed waveform and are not intended to limit the scope of the invention.

The observed waveform to which the invention applies is a complex analog or digitally sampled waveform. The analog form will be used for exposition, and is

f(t)=Ae^{jφ}g(t−t₀)+m(t)+n(t) (2)

where t is a time variable, A is a positive amplitude factor, φ is a phase, g(t) is a known real-valued function, m(t) is a corrupting complex waveform which begins after time t₀, n(t) is a complex noise random process, and j=\sqrt{−1}. It is assumed that g(t)=0 for t≦0 and is increasing and differentiable for a sufficient length of time thereafter (more will be said about this later). Thus, the onset time of g(t) is zero and the onset time of g(t−t₀) is t₀, which is the time to be estimated by the present invention.

In the context of RF ranging without cross-correlation, f(t) is the multipath-corrupted received complex baseband (converted to a zero frequency carrier) signal with additive noise n(t), Ae^{jφ}g(t−t₀) is its noiseless component, and g(t) is the transmitted signal. In this case the signal propagation time would be t₀−0=t₀. Knowledge of g(t) can be obtained from transmitter and receiver characteristics, or from experimental data conducted in an anechoic chamber. The amplitude constant A relates to the received signal strength, the phase φ is due to carrier phase shift in the received signal, and m(t) represents received multipath signal components which begin after time t₀.

Expression (2) can alternately be a complex cross-correlation function, by simply changing the time notation from t to time shift τ. In this case f(τ) is the complex multipath-corrupted cross-correlation function R(τ) at the receiver with additive noise, Ae^{jφ}g(τ−τ₀) is its noiseless component with onset time shift τ₀, and g(τ) is the cross-correlation with an onset time shift of zero as derived from the transmitted signal. The amplitude constant A relates to the received signal strength, the phase φ is due to carrier phase shift in the received signal, and m(τ) represents received multipath signal components in the cross-correlation which begin after time shift τ₀.

A PN code cross-correlation function typically has some small nonzero values for considerable lengths of time before and after its main lobe. Therefore, the onset time τ₀ for such cross-correlation functions is defined as the point where the function just begins to rise uninterruptedly up the leading edge of its main lobe. For most codes the value of the cross-correlation is very close to zero at the onset point, especially for codes called maximal length codes when the number N of chips per code period is large.

The analysis that follows does not depend on the notation used for time. As such, for ease of simplicity no notational change from t to τ will be made when the invention is to be applied to cross-correlation functions.

The invention is configured to accurately estimate t₀ from observation of at least an initial portion of f(t). In some embodiments, the t₀ is estimated from observation of only the initial portion of f(t). The approach used herein is to develop a formula that provides an estimate when noise and multipath is present, but is based on the assumption of no noise and no multipath in the observed initial portion of f(t). Errors due to noise and multipath will be determined by simulations discussed later.

Under these assumptions the observed waveform is

f(t)=Ae^{jφ}g(t−t₀) (3)

The estimate of t₀ will be based on the magnitude (modulus) function F(t) of f(t):

$$F ( t ) = \vert f ( t ) \vert = A \vert g ( t - {t}_{0} ) \vert = \{ \begin{matrix}0 & t \leq {t}_{0} \\ A \vert g ( t - {t}_{0} ) \vert & t > {t}_{0}\end{matrix} \qquad ( 4 )$$

Note that in the absence of noise and multipath, the onset times of f(t), F(t), and g(t−t₀) are the same, namely t₀.

Since multipath components begin after time t₀, expression (4) indicates that t₀ can be determined exactly when there is no noise, even with multipath. However, since the estimate of t₀ must be made when noise is present, the invention estimates t₀ mathematically, using two pieces of information. The first piece is the time t₁ at which F(t) crosses a small positive threshold T. The threshold T is selected to be as small as possible, and still maintain a sufficiently small probability of being crossed by noise alone. A small value of T makes t₁−t₀ small, so that any multipath signal components will have no effect if their delay relative to t₀ is larger than t₁−t₀.

However, a single threshold crossing alone is not enough to determine t₀. As previously mentioned, differing received power levels cause A to vary, which will cause t₁ to vary. To get around this problem without having to observe F(t) at any later time, a second piece of information is used, which is the derivative F′(t₁) of F(t) at the same point t₁ in time where the small threshold T is crossed. At least one advantage of this method is that there is no need to make measurements which extend any further than t₁ into the leading portion of F(t).

At the time t₁ when the threshold T is crossed, we have

T=F(t₁)=A|g(t₁−t₀)|=Ag(t₁−t₀) where t₁>t₀ (5)

The last equality in expression (5) arises from the assumption that g(t) is non-negative for t≦t₁−t₀. Also assuming that g(t) is differentiable for t≦t₁−t₀, let d=F′(t₁), where F′(t₁) is the derivative of F(t) at time t₁. Then,

d=F′(t₁)=Ag′(t₁−t₀) (6)

wherein g′(t) denotes the derivative of the function g(t). The length of the time interval from t₀ to t₁ could be 2-10 nanoseconds for typical local ranging, however the time interval can be longer or shorter and is not intended to be limited to the example of 2-10 nanoseconds.

The amplitude scaling factor A can now be eliminated by forming the ratio

$$\frac{T}{d} = \frac{F ( {t}_{1} )}{{F}^{′} ( {t}_{1} )} = \frac{Ag ( {t}_{1} - {t}_{0} )}{{Ag}^{′} ( {t}_{1} - {t}_{0} )} = \frac{g ( {t}_{1} - {t}_{0} )}{{g}^{′} ( {t}_{1} - {t}_{0} )} \qquad ( 7 )$$

With the additional assumption that g(t) is strictly increasing in a neighborhood of t₁−t₀ so that g′(t₁−t₀)>0, we can let

$$h ( t ) = \frac{g ( t )}{{g}^{′} ( t )}$$

and obtain

$$\frac{T}{d} = h ( {t}_{1} - {t}_{0} ) \qquad ( 8 )$$

Since g(t) is known, so is g′(t), which implies that h(t) is known. If the function h(t) is invertible in an open interval containing both 0 and t₁−t₀ (which almost always is the case in practice), the desired solution for t₀ is

$${t}_{0} = {t}_{1} - {h}^{- 1} ( \frac{T}{d} ) \qquad ( 9 )$$

where h⁻¹ denotes the inverse function of the function h(t). The inverse function goes “backward”. To explain, if we let u=h(t), this means that if the number t is the input to the function h, then h produces u as the output number. But the inverse function reverses the roles of input and output, so that if u=h(t), then t=h⁻¹(u).

An alternative solution for t₀ can be obtained by forming the reciprocal of the ratio in expression (7) and re-defining h(t) as

$$h ( t ) = \frac{{g}^{′} ( t )}{g ( t )} ,$$

which is the reciprocal of its former definition. Forming the reciprocal of the ration in expression (7) results in the new expression (7a)

$$\frac{d}{T} = \frac{{F}^{′} ( {t}_{1} )}{F ( {t}_{1} )} = \frac{{Ag}^{′} ( {t}_{1} - {t}_{0} )}{Ag ( {t}_{1} - {t}_{0} )} = \frac{{g}^{′} ( {t}_{1} - {t}_{0} )}{g ( {t}_{1} - {t}_{0} )} , \qquad ( 7 a )$$

and applying the re-defined h(t) into expression (7a) results in the new expression (8a)

$$\frac{d}{T} = h ( {t}_{1} - {t}_{0} ) , \qquad ( 8 a )$$

and thereby results in the new expression (9a) for the alternative solution for t₀

$${t}_{0} = {t}_{1} - {h}^{- 1} ( \frac{d}{T} ) . \qquad ( 9 a )$$

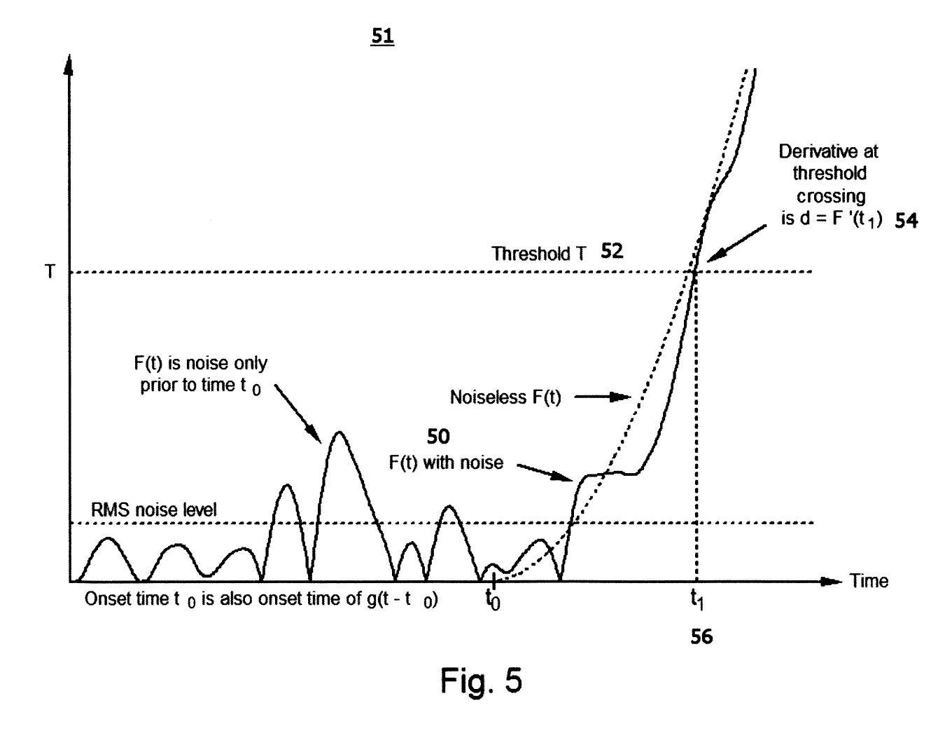

FIG. 5 is a plot 51 of the initial portion of the magnitude function F(t) of a received single-pulse signal in additive noise, showing in accordance with the invention the time t₁ that F(t) crosses a threshold T, which is where the derivative F′(t₁) of F(t) is calculated. FIG. 5 illustrates the initial portion of the magnitude function F(t) 50 as it passes through the threshold T 52, and the derivative d=F′(t₁) 54 at the time t₁ 56 of threshold crossing.

The foregoing description can be clarified by giving a concrete example in which the initial portion of the function g(t) is quadratic:

$$g ( t ) = \{ \begin{matrix}0 & t \leq 0 \\ {t}^{2} & t > 0\end{matrix} {g}^{′} ( t ) = \{ \begin{matrix}0 & t \leq 0 \\ 2 t & t > 0\end{matrix} \qquad ( 10 )$$

Then the noiseless and multipath-free magnitude function is

$$F ( t ) = \{ \begin{matrix}0 & t \leq {t}_{0} \\ Ag ( t - {t}_{0} ) = {A ( t - {t}_{0} )}^{2} & t > {t}_{0}\end{matrix} \qquad ( 11 )$$

At the time t₁ when the threshold T is crossed, we have

T=F(t₁)=Ag(t₁−t₀)=A(t₁−t₀)² where t₁>t₀

d=F′(t₁)=Ag′(t₁−t₀)=2A(t₁−t₀) where t₁>t₀ (12)

Thereby defining the function h(t) as follows:

$$h ( t ) = \frac{g ( t )}{{g}^{′} ( t )} = \frac{{t}^{2}}{2 t} = \frac{t}{2} where t > 0 \qquad ( 13 )$$

Since h(t)=t/2, it follows that h⁻¹(t/2)=t. Making a variable change by letting u=t/2, we can write h⁻¹(u)=2u. Thus, the output of this inverse function is double its input.

It then follows that

$$\frac{T}{d} = \frac{F ( {t}_{1} )}{{F}^{′} ( {t}_{1} )} = \frac{Ag ( {t}_{1} - {t}_{0} )}{{Ag}^{′} ( {t}_{1} - {t}_{0} )} = \frac{{( {t}_{1} - {t}_{0} )}^{2}}{2 ( {t}_{1} - {t}_{0} )} = \frac{{t}_{1} - {t}_{0}}{2} = h ( {t}_{1} - {t}_{0} ) \\ where {t}_{1} > {t}_{0} \qquad ( 14 )$$

Since h(t₁−t₀)=T/d, it follows that

$${t}_{1} - {t}_{0} = {h}^{- 1} ( \frac{T}{d} ) = \frac{2 T}{d} ⇒ {t}_{0} = {t}_{1} - \frac{2 T}{d} \qquad ( 15 )$$

Even though noise and multipath have been neglected in the foregoing description, the solution for t₀ given by expression (9) can still be used when the waveform f(t) includes noise and multipath. In this case, the threshold crossing time t₁ and d=F′(t₁) in expression (9) will be noisy and affected by any multipath present at time t₁. However, the inverse function h⁻¹ is unaffected, since it arises from the known noiseless functions g(t) and g′(t). Since the error in estimating t₀ due to noise and multipath is difficult to analyze, the effects of these error sources have been determined by simulations to be discussed later.

When only noise is present, F(t)=|n(t)|, which is a non-negative random process whose magnitude can be described by its root-mean-square (RMS) value. To reduce false threshold crossings to an acceptable level, in some embodiments the threshold T will generally be set somewhere in the range of 4-5 times the noise-only RMS value. However, in other embodiments, the threshold T can be set to a higher or lower range and is not intended to be limited to 4-5 times the noise-only RMS value. The setting can be automatic, based on periodic RMS measurements of the noise in the absence of signal. Additionally, threshold crossings can be confirmed by checking that the waveform magnitude continues to rise well beyond the point at which the threshold is crossed.

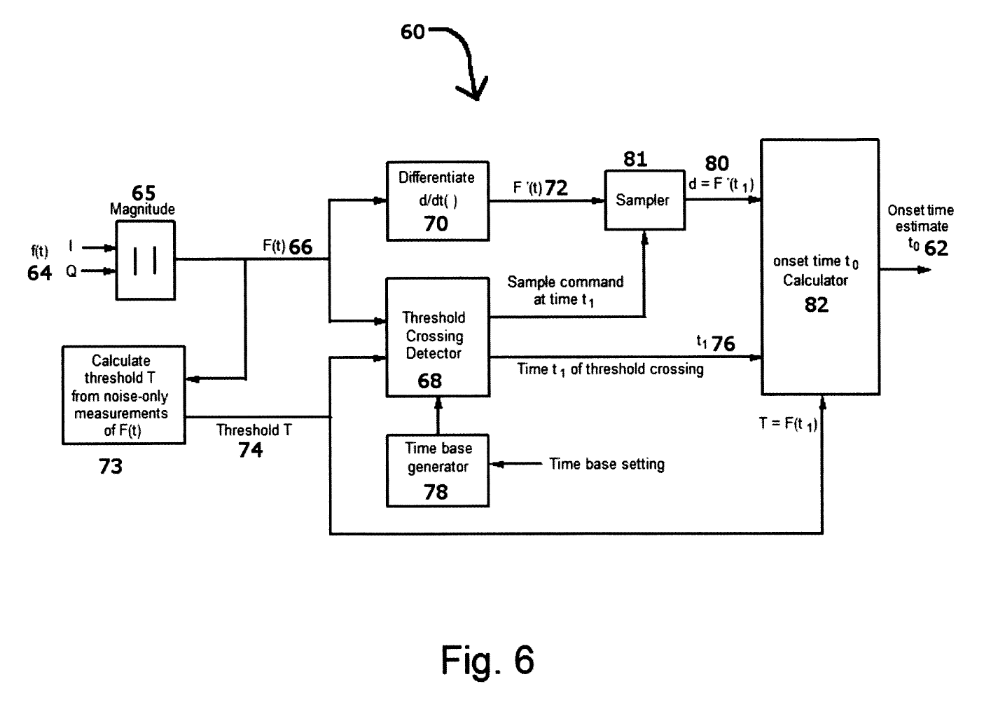

FIG. 6 is a block diagram of an embodiment of a wireless communication device 60, such as but not limited to a receiver, configured to estimate the onset time t₀ of a waveform embedded in noise by observation of the noisy waveform f(t), including the calculation of a small positive threshold T above the measured RMS noise level. In other embodiments, the device 60 can also comprise an apparatus for estimating the onset time of a waveform, and is not intended to be limited to a receiver.

The receiver 60 estimates the onset time t₀ 62 of g(t−t₀) by using the waveform f(t) 64, which can be in analog or digitally sampled form. First, the magnitude function F(t) 66 of f(t) 64 is computed by a magnitude function generator 65 in accordance with expression (4) above, and is fed to a threshold detector 68 and a differentiator 70. The output of the differentiator is the derivative F′(t) 72 of F(t) 66. Based on noise-only measurements of F(t) 66, a positive threshold T 74 is computed for use by the threshold detector 68, and is typically 4-5 times the RMS noise level.

When F(t) 66 crosses the threshold T 74, the threshold detector 68 records the threshold crossing time t₁ 76 according to a time base generator 78, and also sends a command to a sampler 81 to sample the output of the differentiator 70. The sampled output is the derivative d=F′(t₁) 80 of F(t) 66 at time t₁ 76. The quantities d, t₁, and T are then inputted into a calculator 82 and are used by the calculator 82 to compute the onset time t₀ 62 in accordance with expression (9), while in other embodiments the onset time can be computed in accordance with expression (9a).

The time base generator 78 can be set by the receiver 60 by means well-known in the art such that the estimate of t₀ (or the estimate of cross-correlation onset time τ₀) according to the time base can be converted into signal TOA, again by means well-known in the art.

In embodiments wherein the input to the differentiator 70 is an analog signal, the differentiator can comprise an analog filter wherein the analog filter output closely approximates the derivative of the input. In other embodiments wherein the input is a digitally sampled signal, the differentiator 70 can comprise a digital filter or two successive samples of the input can be used to form a difference quotient which closely approximates the derivative.

An Embodiment Using an Improved Cross-Correlation Function

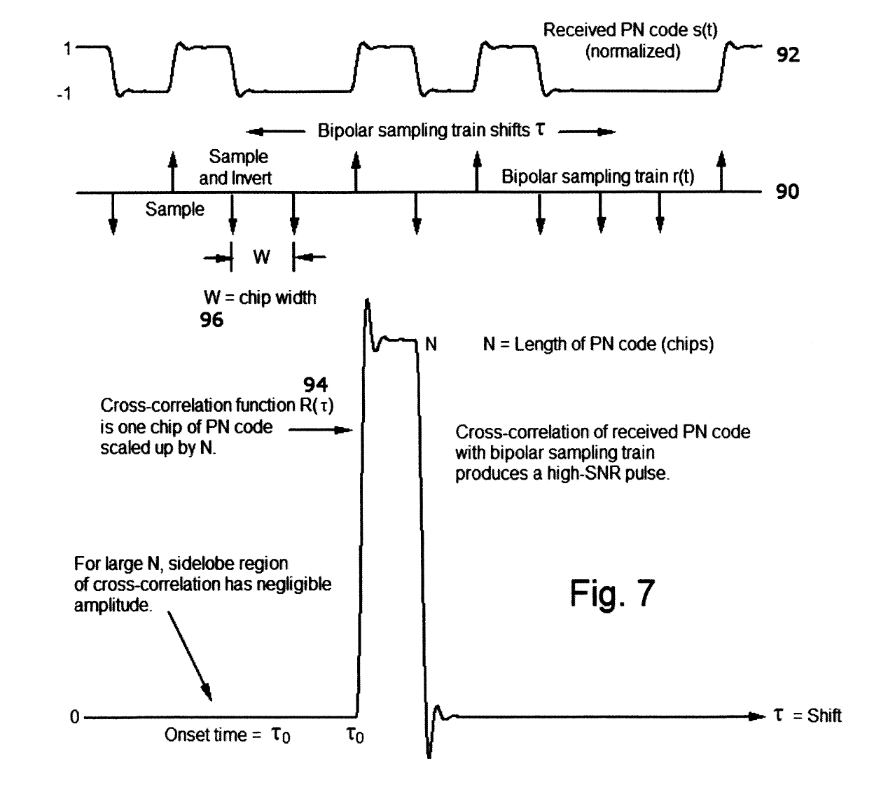

As previously mentioned, a typical cross-correlation function using a pseudorandom code does not have the best characteristics for estimating onset time τ₀, because the leading part of its main lobe does not rise rapidly. A much better cross-correlation function for this purpose can be obtained as shown in FIG. 7, wherein the receiver-generated replica is replaced by a bipolar sampling train 90 with the same sequence of polarities as the received PN code 92. The resulting cross-correlation function R(τ) 94 produces a high-SNR version of a single PN code chip with a risetime limited only by filtering in the transmitter and receiver. Consequently, the estimate of onset time is much less affected by noise.

For such a cross-correlation function, the bipolar sampling train r(t) 90 can be represented by a train of unit impulses expressed as

$$r ( t ) = {\sum }_{n = 0}^{N - 1} {ɛ}_{n} δ ( t - nW ) \qquad ( 16 )$$

where W is the width 96 of a code chip, and the constants εₙ are the impulse polarities, each of which is either +1 or −1. The sequence of impulse polarities matches the polarities of the received PN code. Then,

$$R ( τ ) = {\int }_{0}^{NW} s ( t ) r ( t - τ ) d t = {\int }_{0}^{NW} s ( t ) [ {\sum }_{n = 0}^{N - 1} {ɛ}_{n} δ ( t - nW - τ ) ] d t = {\sum }_{n = 0}^{N - 1} {ɛ}_{n} s ( nW + τ ) \qquad ( 17 )$$

FIG. 7 discloses the formation of a cross-correlation function, according to an embodiment of the invention, with a short risetime, having an onset time τ₀ which can be determined by the present invention with much better accuracy than the onset time of a conventional cross-correlation function.

This type of cross-correlation was introduced in U.S. Pat. No. 7,403,559, “Binary-Valued Signal Modulation Compression for High Speed Cross-Correlation,” Jul. 22, 2008, with Fisher and Weill as co-inventors. The cross-correlation function described in that patent is called the compressed signal.

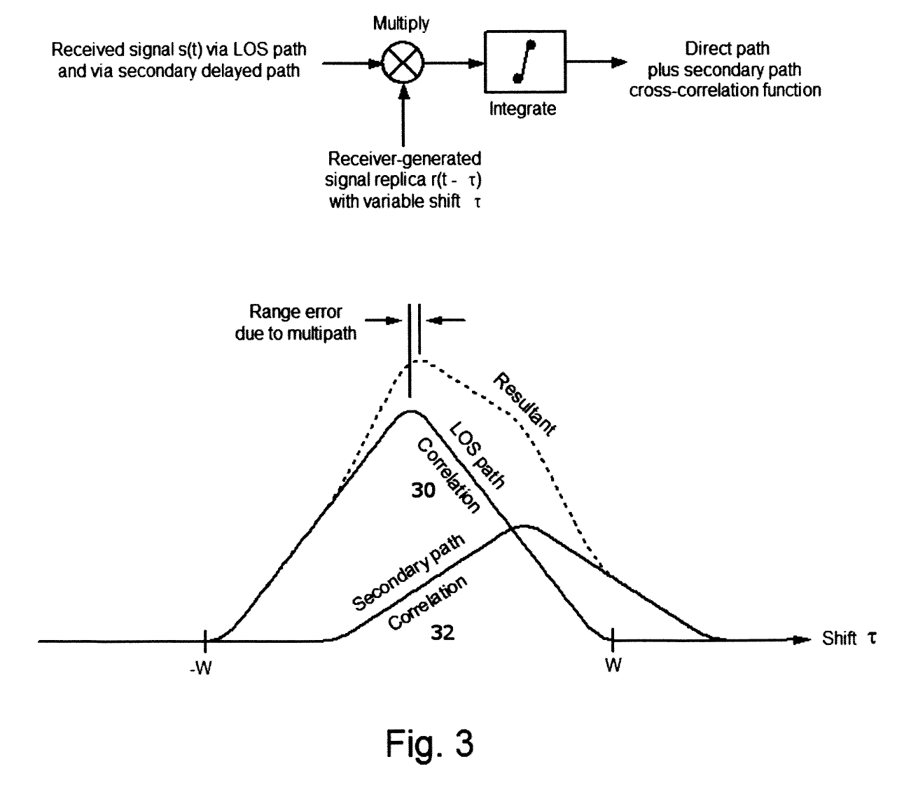

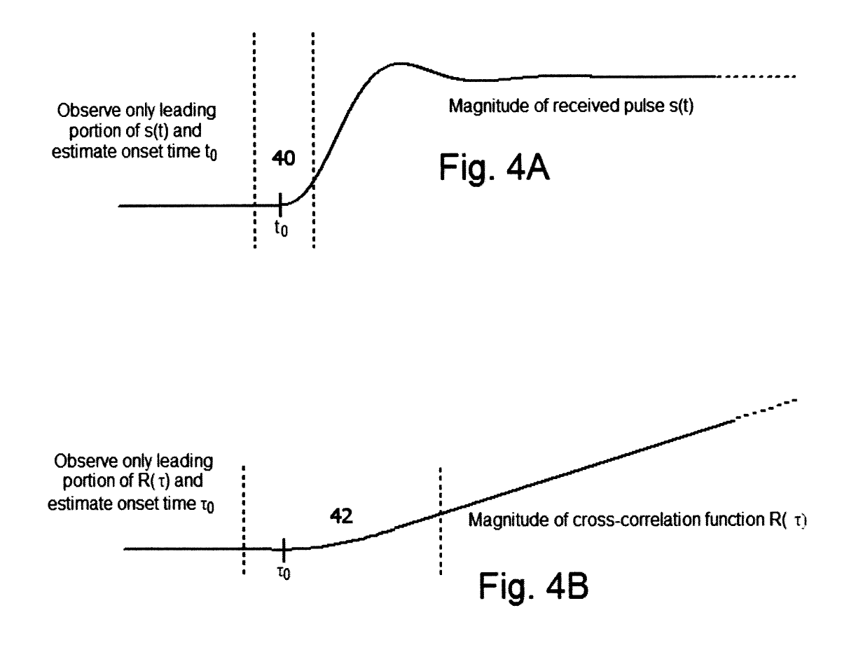

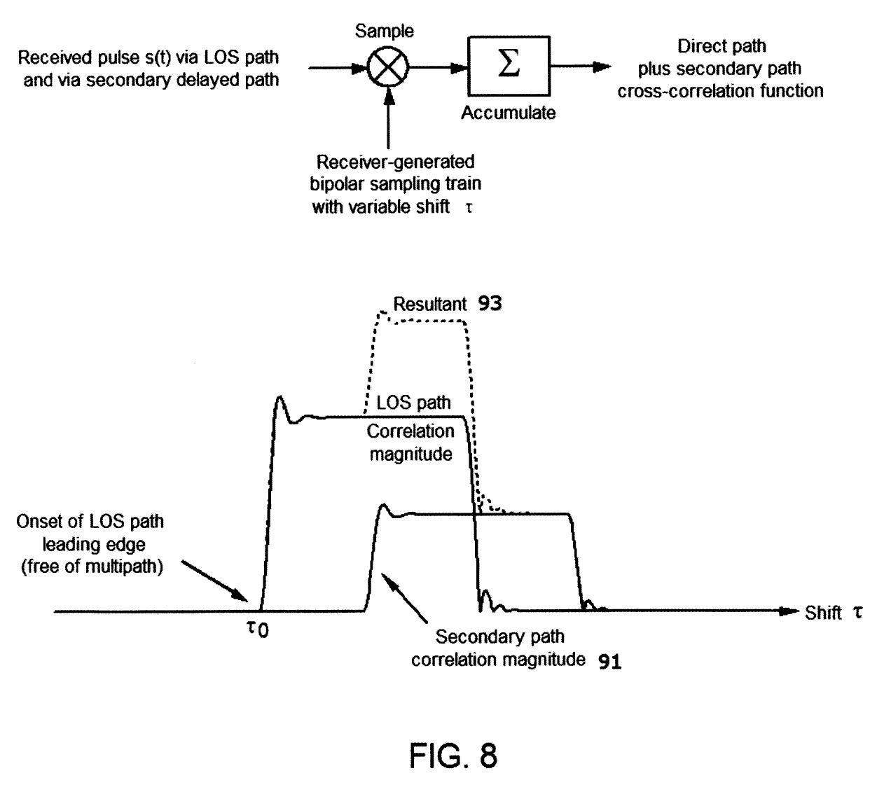

FIG. 8 shows the advantage of this cross-correlation function in the presence of multipath, as compared to FIG. 3. The resultant cross-correlation function 93 is not negatively impacted by multipath components 91 beyond a small initial portion of R(τ) and the multipath components 91 cannot cause error in estimating the onset time τ₀. FIG. 8 discloses that the embodiment of the cross-correlation function of FIG. 7, when used in a generic leading edge approach to estimating TOA, is much more resistant to multipath error as compared to using the conventional cross-correlation shown in FIG. 3.

Simulation Results

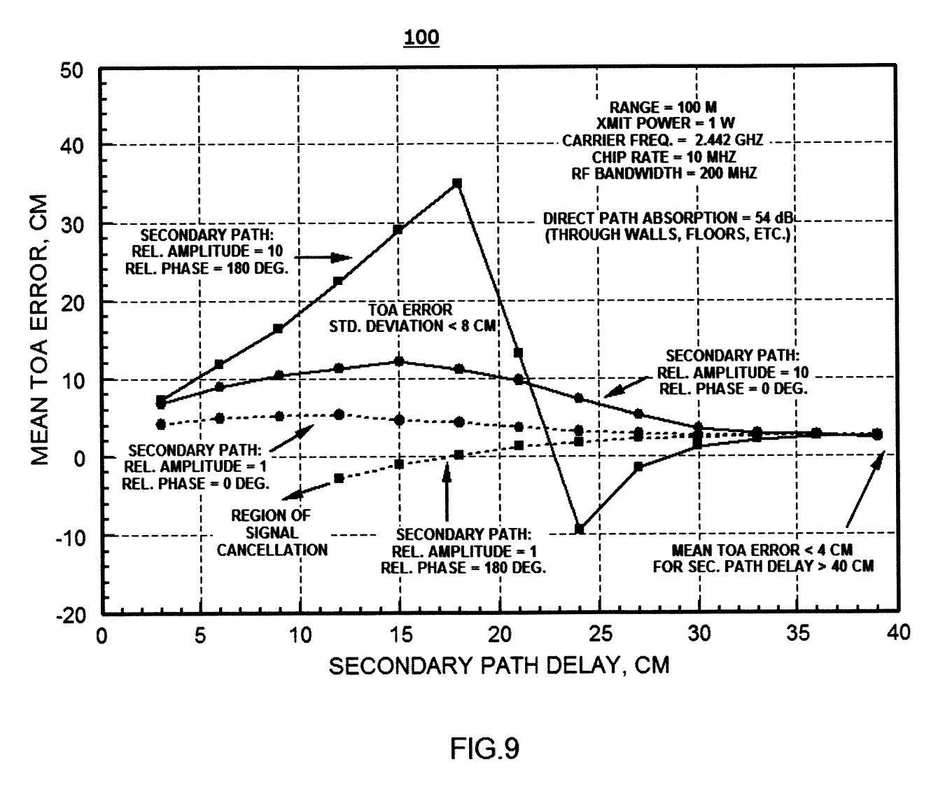

FIG. 9 shows a diagram 100 of simulation results, wherein the estimation of TOA uses the embodiment of the improved cross-correlation function described above and shown in FIG. 7 in the presence of multipath. The parameters values used are as follows: range=100 m, transmit power=1 Watt, carrier frequency=2.442 GHz, maximal length PN code with chipping rate=10 MHz and period N=2²⁰−1=1,048,575 chips, RF cutoff bandwidth=200 MHz, and TOA estimation update rate=1 sec. Each update uses 10⁷ code chips. The signal is centered in the 2.4 GHz IMS band and even though it has some spectral power outside the IMS band, it satisfies the FCC out-of-band spectral power density requirements. To make the simulations more realistic for an indoor scenario, an additional 54 dB of loss was added to the spreading loss of the direct path signal to account for absorption from walls, floors, etc.

The curves of FIG. 9 show the mean TOA error as a function of secondary path delay relative to the direct signal path. The dashed curves show the mean error for a secondary path amplitude equal to that of the direct path. The solid curves show the error for a secondary path amplitude 10 times greater than that of the direct path, which is a very severe multipath condition.

The curves with the circular data points show the mean TOA error when the secondary path phase is 0 degrees relative to the direct path, and curves with the square data points show the error for 180 degrees relative phase.

In all cases the standard deviation of TOA error is less than 8 cm.

For secondary path delays greater than 40 cm, the mean TOA error is less than 4 cm, regardless of the relative amplitude and phase of the secondary path. This error is the same as the error without any multipath.

Note that there is an unavoidable region of signal cancellation at very small path separations when the secondary path amplitude is the same as that of the direct path and its relative phase is 180 degrees. In this region there is not enough received signal power to properly estimate the signal TOA.

It will be understood that the above description of the invention illustrates its principles, and that various modifications could be made by those skilled in the art without departing from the scope and spirit of the invention. Also, it will be understood by those skilled in the art that the invention can be used with signals other than RF signals, such as but not limited to sonic or optical signals. It will be noted that a wide variety of waveforms can be used with the invention.

I claim:

1. A method for estimating an onset time t₀ from observation of a complex waveform
f(t)=Ae^{jφ}g(t−t₀)+m(t)+n(t)
wherein t is a time variable, A is a positive amplitude factor, φ is a phase, g(t) is a known differentiable real-valued function which is zero for t≦0 and increasing for a sufficiently long time thereafter, m(t) is a corrupting complex waveform which begins after time t₀, n(t) is a complex noise random process, and j=\sqrt{−1}, comprising the steps of:
receiving the complex waveform f(t);
computing a magnitude function F(t) of said complex waveform;
computing a derivative F′(t) of said magnitude function F(t);
determining a time t₁ that said magnitude function F(t) crosses a positive threshold T;
sampling said derivative F′(t) at said time t₁ to derive a value d=F′(t₁);
estimating an onset time t₀ of said function g(t−t₀) according to a formula
$${t}_{0} = {t}_{1} - {h}^{- 1} ( \frac{T}{d} )$$
wherein a function h⁻¹ is an inverse of a function
$$h ( t ) = \frac{g ( t )}{{g}^{′} ( t )} .$$

2. The method of claim 1, wherein said complex waveform f(t) is a complex baseband signal from a radio receiver and Ae^{jφ}g(t−t₀) is a line of sight (LOS) noiseless component of said complex waveform f(t).

3. The method of claim 2, wherein time variable notations t, t₀ and t₁, have been replaced by time shift notations τ, τ₀, and τ₁ to indicate that said waveform is a complex cross-correlation function, wherein an onset time τ₀ of said complex cross-correlation function is estimated.

4. The method of claim 3, wherein said complex cross-correlation function is generated by using a receiver generated bipolar sampling train to produce said complex cross-correlation function having the form
$$R ( τ ) = {\sum }_{n = 0}^{N - 1} {ɛ}_{n} s ( nW + τ )$$
wherein s(nW+τ) are sample values of a complex baseband signal s(t) comprising:
a time shift τ;
a time spacing W between successive sampling times;
polarity values εₙ of +1 and −1 for said bipolar sampling train; and
a number of samples N of said complex baseband signal.

5. The method of claim 1, further comprising the step of:
calculating said positive threshold T from root-mean-square (RMS) measurements of said magnitude function F(t) in which only said noise n(t) is present.

6. The method of claim 5, wherein said positive threshold T is utilized to determine said time t₁ that said magnitude function F(t) crosses said positive threshold T.

7. The method of claim 5, wherein said positive threshold T is as small as possible while keeping the probability of noise-only threshold crossings acceptably small.

8. A wireless communication device for estimating an onset time t₀ from observation of a complex waveform
f(t)=Ae^{jφ}g(t−t₀)+m(t)+n(t)
wherein t is a time variable, A is a positive amplitude factor, φ is a phase, g(t) is a known differentiable real-valued function which is zero for t≦0 and increasing for a sufficiently long time thereafter, m(t) is a corrupting complex waveform which begins after time t₀, n(t) is a complex noise random process, and j=\sqrt{−1}, said device comprising:
a magnitude function generator;
a differentiator;
a threshold crossing detector, wherein an output of said magnitude function generator is supplied to each of said differentiator and said threshold crossing detector;
a time base generator configured to provide a time base generator signal to said threshold crossing detector;
a sampler coupled to an output of said differentiator; and
an onset time calculator, wherein outputs of at least said sampler and said threshold crossing detector are supplied to said onset time calculator to estimate said onset time t₀.

9. The device of claim 8, wherein said magnitude function generator generates a magnitude function F(t) of said complex waveform f(t).

10. The device of claim 9, wherein said differentiator computes a derivative F′(t) of said magnitude function F(t).

11. The device of claim 10, wherein said threshold crossing detector detects a time t₁ that said magnitude function F(t) crosses a positive threshold T according to said time base generator.

12. The device of claim 11, wherein said threshold crossing detector transmits a sampling command at said time t₁ to said sampler, such that said sampler samples said derivative F′(t) at said time t₁ to derive a value d=F′(t₁).

13. The device of claim 8, further comprising a threshold calculator, wherein said threshold calculator receives said output of said magnitude function generator to calculate a positive threshold T using root-mean-square (RMS) measurements of said magnitude function F(t) in which only said noise n(t) is present.

14. The device of claim 13, wherein a threshold calculator output is provided to said threshold crossing detector.

15. The device of claim 13, wherein a threshold calculator output is provided to said onset time calculator, such that said threshold calculator output is utilized to estimate said onset time t₀.

16. The device of claim 8, wherein said onset time t₀ of a function g(t−t₀) is estimated according to a formula
$${t}_{0} = {t}_{1} - {h}^{- 1} ( \frac{T}{d} )$$
wherein a function h⁻¹ is an inverse of a function
$$h ( t ) = \frac{g ( t )}{{g}^{′} ( t )} .$$

17. The device of claim 8, wherein said onset time t₀ of a function g(t−t₀) is estimated according to a formula
$${t}_{0} = {t}_{1} - {h}^{- 1} ( \frac{d}{T} )$$
wherein a function h⁻¹ is an inverse of a function
$$h ( t ) = \frac{{g}^{′} ( t )}{g ( t )} .$$

18. The device of claim 8, wherein said complex waveform f(t) is a complex baseband signal from a radio receiver and Ae^{jφ}g(t−t₀) is a line of sight (LOS) noiseless component of said complex waveform f(t).

19. The device of claim 18, wherein time variable notations t, t₀ and t₁, have been replaced by time shift notations τ, τ₀, and τ₁, respectively, to indicate that said waveform is a complex cross-correlation function, wherein an onset time τ₀ of said complex cross-correlation function is estimated.

20. The device of claim 19, wherein said complex cross-correlation function is generated by using a receiver generated bipolar sampling train to produce said complex cross-correlation function having the form
$$R ( τ ) = {\sum }_{n = 0}^{N - 1} {ɛ}_{n} s ( nW + τ )$$
wherein s(nW+τ) are sample values of a complex baseband signal s(t) comprising:
a time shift τ;
a time spacing W between successive sampling times;
polarity values εₙ of +1 and −1 for said bipolar sampling train; and
a number of samples N of said complex baseband signal.

21. A method for estimating an onset time t₀ from observation of a complex waveform
f(t)=Ae^{jφ}g(t−t₀)+m(t)+n(t)
wherein t is a time variable, A is a positive amplitude factor, φ is a phase, g(t) is a known differentiable real-valued function which is zero for t≦0 and increasing for a sufficiently long time thereafter, m(t) is a corrupting complex waveform which begins after time t₀, n(t) is a complex noise random process, and j=\sqrt{−1}, comprising the steps of:
receiving the complex waveform f(t);
computing a magnitude function F(t) of said complex waveform;
computing a derivative F′(t) of said magnitude function F(t);
determining a time t₁ that said magnitude function F(t) crosses a positive threshold T;
sampling said derivative F′(t) at said time t₁ to derive a value d=F′(t₁);
estimating an onset time t₀ of said function g(t−t₀) according to a formula
$${t}_{0} = {t}_{1} - {h}^{- 1} ( \frac{d}{T} )$$
wherein a function h⁻¹ is an inverse of a function
$$h ( t ) = \frac{{g}^{′} ( t )}{g ( t )} .$$
